(19) United States
(12) Patent Application Publication
(10) Pub. No.: US 2011/0036502 A1
(43) Pub. Date: Feb. 17, 2011

(54) TAPE FEEDING DEVICE AND TAPE PRINTING APPARATUS INCLUDING THE SAME

(75) Inventor: Hideki Sakano, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/844,210

(22) Filed: Jul. 27, 2010

(30) Foreign Application Priority Data
Aug. 12, 2009 (JP) 2009-187152

(51) Int. Cl. B32B 38/14; B32B 37/00

(52) U.S. Cl. 156/378; 156/387

(57) ABSTRACT

A tape feeding device includes: a device main body to which a tape body, which has a tape-shaped material wound around a tape core, is detachably attached, wherein the device main body includes a tape feeding unit which feeds the tape-shaped material while drawing the tape-shaped material from the tape core, and a rotation detecting unit which detects the rotation condition of the tape core including rotation stop in cooperation with the tape core.

The entire disclosure of Japanese Patent Application No. 2009-187152, filed on Aug. 12, 2009, is expressly incorporated by reference herein.

### BACKGROUND

1. Technical Field

The present invention relates to a tape feeding device which draws tape-shaped material wound around a tape core in the shape of roll to feed the tape-shaped material, and a tape printing apparatus including the tape feeding device.

2. Related Art

A known tape feeding device (tape printing apparatus) recognizes the end of a tape-shaped material based on detection of a detection portion formed in the vicinity of the end of the wound tape-shaped material using a photo-sensor (photo-sensor as a rotation detecting unit) provided adjacent to a cutter at a position downstream from a thermal head (see JP-A-08-267881).

According to this type of tape feeding device, the detection portion is provided as a hole (or transparent portion) on the tape-shaped material through which light from the photo-sensor passes. When the photo-sensor detects the detection portion (tape end detection), feeding of the tape-shaped material and printing on the tape-shaped material are both stopped. In this case, the length from the detection portion to the end of the tape-shaped material is determined equivalent to the length (distance) from the detection position of the photo-sensor to the printing position of the thermal head such that printing is not performed without the tape-shaped material supplied to the printing position.

According to this type of tape feeding device, however, the tape-shaped material is required to have the detection portion, which increases the manufacturing cost of the tape-shaped material. Moreover, when the tape-shaped material is transparent or semitransparent, detection of the detection portion by the detecting unit such as the photo-sensor becomes extremely difficult. In this case, there is a possibility that the tape end (detection portion) is not accurately detected depending on the types of tape material. Furthermore, the detecting unit cannot detect the condition of the tape-shaped material during feeding, and thus cannot determine whether the tape-shaped material is being fed in an appropriate manner or not.

### SUMMARY

It is an advantage of some aspects of the invention to provide a tape feeding device capable of securely detecting the tape end of a tape-shaped material without providing a special process on the tape-shaped material and also capable of recognizing the feeding condition of the tape-shaped material, and a tape printing apparatus including the tape feeding device.

A tape feeding device according to a first aspect of the invention includes: a device main body to which a tape body, which has a tape-shaped material wound around a tape core, is detachably attached. The device main body includes: a tape feeding unit which feeds the tape-shaped material while drawing the tape-shaped material from the tape core; and a rotation detecting unit which detects the rotation condition of the tape core including rotation stop in cooperation with the tape core.

According to this structure, the rotation condition of the tape core including rotation stop is detected in cooperation with the tape core. Thus, the condition of the tape-shaped material being drawn and fed can be determined based on the condition of the tape core. For example, whether the tape-shaped material is being drawn and fed in the normal condition or not can be determined based on the detection of the rotation of the tape core in synchronization with the tape feeding unit. In addition, the condition that the tape-shaped material is finished (tape end) and the abnormal feeding condition of the tape-shaped material can be determined based on the detection of rotation stop of the tape core. In this case, the tape end and the like can be accurately detected without providing a special process indicating the tape end on the tape-shaped material. Accordingly, the tape-shaped material (and the tape body as well) can be manufactured at low cost.

It is preferable that the device main body further includes a control unit which controls the operation of the tape feeding unit, and that the control unit stops the operation of the tape feeding unit when the rotation detecting unit detects rotation stop of the tape core.

According to this structure, supply of the tape-shaped material is compulsorily stopped after the tape-shaped material is used up. Thus, the tape end, the abnormal feeding condition of the tape-shaped material and the like can be recognized by the user. Accordingly, conditions such as looseness and cut of the tape-shaped material wound around the tape core or during feeding can be detected as well as the tape end. Moreover, in the process of printing on the tape-shaped material, the process can be stopped in accordance with supply stop of the tape-shaped material.

It is preferable that the device main body further includes a control unit which controls the operation of the tape feeding unit and a type detecting unit which detects the type of the attached tape body. The control unit includes a control table storing various parameters for each type of the tape body. The control unit refers to the control table based on the detection result received from the type detecting unit. The control unit calculates the remaining amount of the tape-shaped material based on the feeding speed of the tape feeding unit, the detection result received from the rotation detecting unit, and the reference result obtained from the control table.

According to this structure, the remaining amount of the tape-shaped material can be easily calculated regardless of the structure (such as color and type) of the tape-shaped material.

It is possible to use a correspondence table showing the correlation between the rotation condition of the rotation detecting unit and the remaining amount of the tape-shaped material as the control table. In this case, the remaining amount can be calculated based on the detection result received from the rotation detecting unit only by referring to the control table.

It is preferable that the tape core includes at least a detection portion, and that the rotation detecting unit has a photo-sensor facing the detection portion.

In addition, it is preferable that the tape core includes at least a detection portion, and that the rotation detecting unit has a microswitch which contacts the detection portion to be turned on or off.

According to these cases, the rotation of the tape core can be accurately detected by the simplified structure. Accordingly, the detection of the tape end and the feeding condition of the tape-shaped material and the calculation of the remaining amount of the tape-shaped material can be highly accurately achieved.

It is preferable that the device main body further includes a notifying unit which notifies the rotation condition of the tape-shaped material.

The notifying unit allows the user to easily check the time for replacement of the tape body and whether the necessary amount of the tape-shaped material for use is left or not.

The notifying unit may notify the condition of the tape end and looseness of the tape-shaped material as well as the remaining amount. The notifying unit may be provided by a warning lamp such as LED, warning sound from a speaker or the like, or may be displayed on a device display as indicator display.

A tape printing apparatus according to a second aspect of the invention includes: the tape feeding device described above; and a tape printing unit which performs printing on the tape-shaped material drawn and fed.

When the tape-shaped material is a printing tape in this structure, the drawing condition of the printing tape, that is, whether the printing tape is being fed in the normal condition or not can be accurately determined. Thus, feeding of the tape-shaped material can be automatically stopped based on the detection that the tape-shaped material is finished or that the tape-shaped material is loosened or entangled, for example. Accordingly, the problems such as continuation of the printing process by the tape printing unit without supply of the tape-shaped material can be avoided.

### BRIEF DESCRIPTION OF THE DRAWINGS

The invention will be described with reference to the accompanying drawings, wherein like numbers reference like elements.

FIG. 1 is a perspective view illustrating the external appearance of a tape printing apparatus when a cover of the tape printing apparatus is opened.

FIG. 2 is a plan view of a tape cartridge from which an upper case is cut and removed.

FIG. 3 is a perspective view illustrating a cross section of the tape cartridge taken along a line A-A in FIG. 1.

FIG. 4 schematically illustrates a tape cartridge according to a first embodiment, wherein: apart (a) is a plan view showing a part of the tape cartridge; and a part (b) is a cross-sectional view of the tape cartridge taken along a line A-A in the part (a).

FIG. 5 is a block diagram showing a control device of a tape printing apparatus.

FIG. 6 shows the relationship between the remaining amount of a printing tape and a rotation detection signal detected by a rotation detecting unit.

FIG. 7 shows respective constants and variables used for calculation of the remaining amount of the printing tape.

FIG. 8 schematically illustrates a tape cartridge according to a third embodiment, wherein: a part (a) is a plan view showing a part of the tape cartridge; and a part (b) is a cross-sectional view of the tape cartridge taken along a line A-A in the part (a).

FIG. 9 schematically illustrates a tape cartridge according to a fourth embodiment, wherein: a part (a) is a plan view showing a part of the tape cartridge; and a part (b) is a cross-sectional view of the tape cartridge taken along a line A-A in the part (a).

FIG. 10A illustrates a tape cartridge, a tape body and other components according to a modified example of the fourth embodiment, wherein: a part (a) is a plan view showing these components; and a part (b) is a cross-sectional view of the tape cartridge taken along a line A-A shown in the part (a).

FIG. 10B illustrates a tape cartridge, a tape body and other components according to another modified example of the fourth embodiment, wherein: a part (a) is a plan view showing these components; and a part (b) is a cross-sectional view of the tape cartridge taken along a line B-B shown in the part (a).

FIG. 11 illustrates a tape cartridge, a tape body and other components according to a fifth embodiment, wherein: a part (a) is a plan view showing these components; and a part (b) is a cross-sectional view of the tape cartridge taken along a line A-A shown in the part (a).

### DESCRIPTION OF EXEMPLARY EMBODIMENTS

A tape printing apparatus according to an embodiment of the invention is hereinafter described with reference to the appended drawings. This tape printing apparatus draws a printing tape (tape-shaped material) and an ink ribbon from an attached tape cartridge, performs printing while simultaneously feeding the printing tape and the ink ribbon in tension, and cuts a printed portion of the printing tape into a label (tape piece).

### First Embodiment

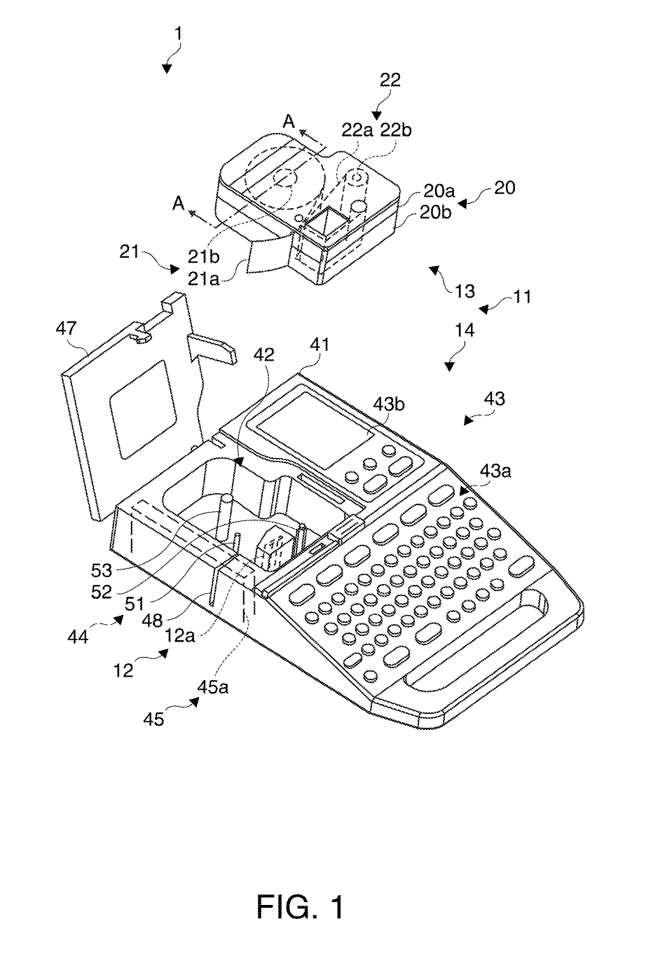

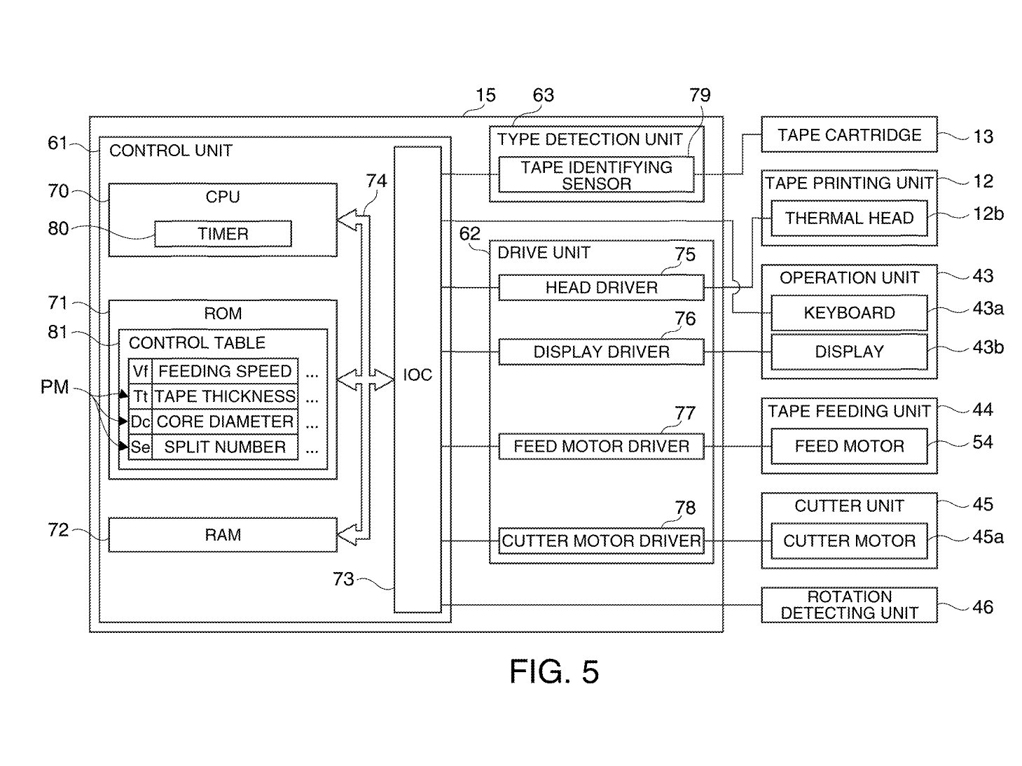

A tape printing apparatus 1 is now described with reference to FIG. 1. FIG. 1 is a perspective view illustrating the external appearance of the tape printing apparatus 1 when a cover of the printing device 1 is opened. The tape printing apparatus 1 includes a tape feeding device 11 having a device main body 14 to which a tape cartridge 13 containing a printing tape 21a, an ink ribbon 22 and the like is detachably attached, and a tape printing unit 12 which performs printing on the printing tape 21a drawn and fed from the tape cartridge 13. The tape printing apparatus 1 further includes a control device 15 (see FIG. 5) which supervises and controls the printing process and the like.

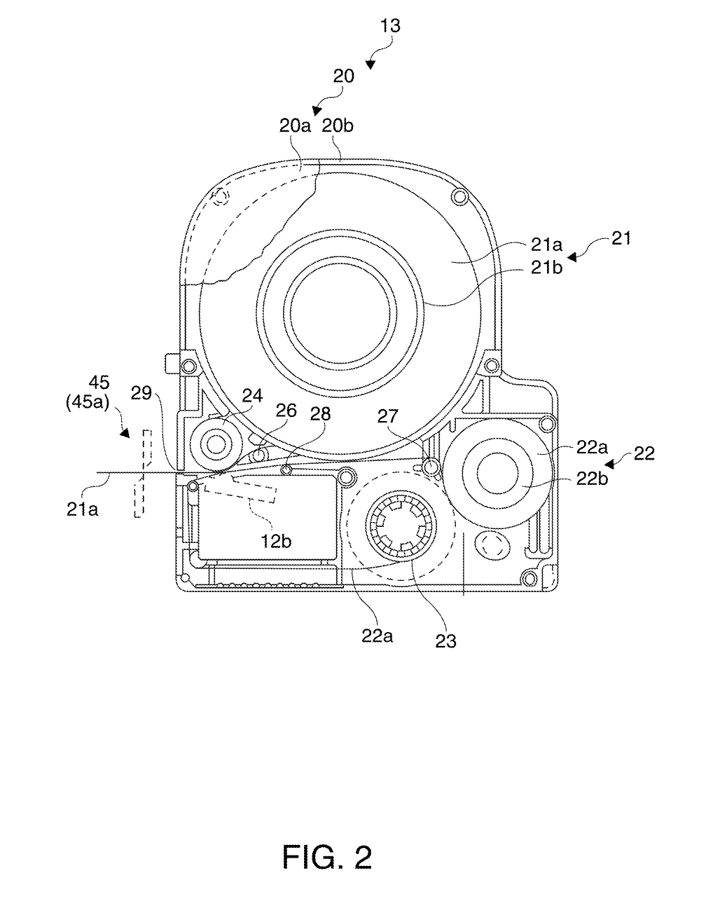

FIG. 2 is a plan view illustrating the tape cartridge 13 from which an upper case 20a is cut and removed. As illustrated in FIGS. 1 and 2, the outer case of the tape cartridge 13 is formed by a resin cartridge case 20 having the upper case 20a and a lower case 20b. The cartridge case 20 of the tape cartridge 13 accommodates a tape body 21 having the printing tape 21a wound around a tape core 21b, a ribbon body 22 having the ink ribbon 22a wound around a ribbon core 22b, a winding core 23 around which the used ink ribbon 22a is wound, and a platen roller 24 which draws the printing tape 21a from the tape body 21 and feeds the printing tape 21a. As can be seen from FIG. 2, the tape body 21 is positioned at the center in the upper area, the ribbon body 22 is positioned on the right side in the lower area, and the winding core 23 is positioned at the center in the lower area. When the tape cartridge 13 is attached to the device main body 14, a thermal head 12a of the tape printing unit 12 is located with respect to the printing tape 21a in such a position as to be opposed to the platen roller 24.

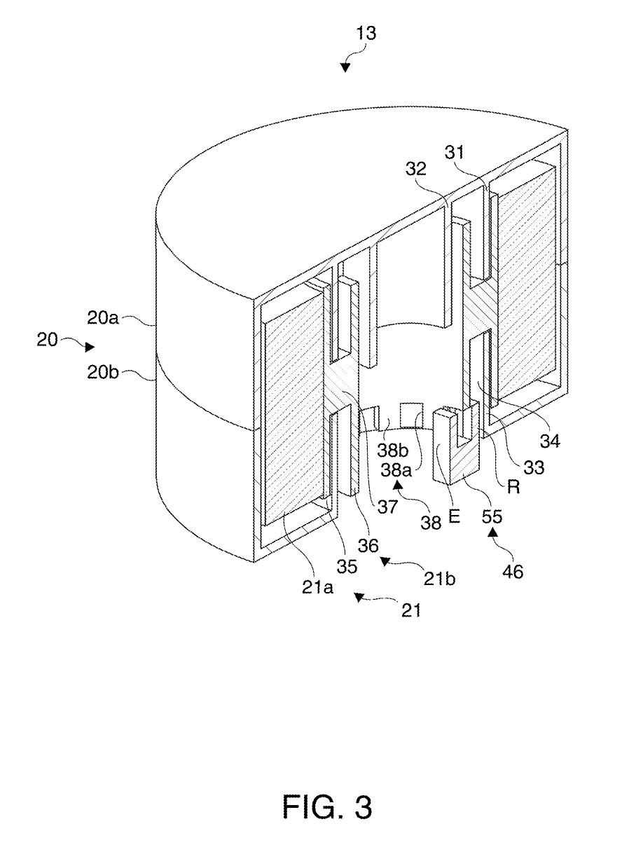

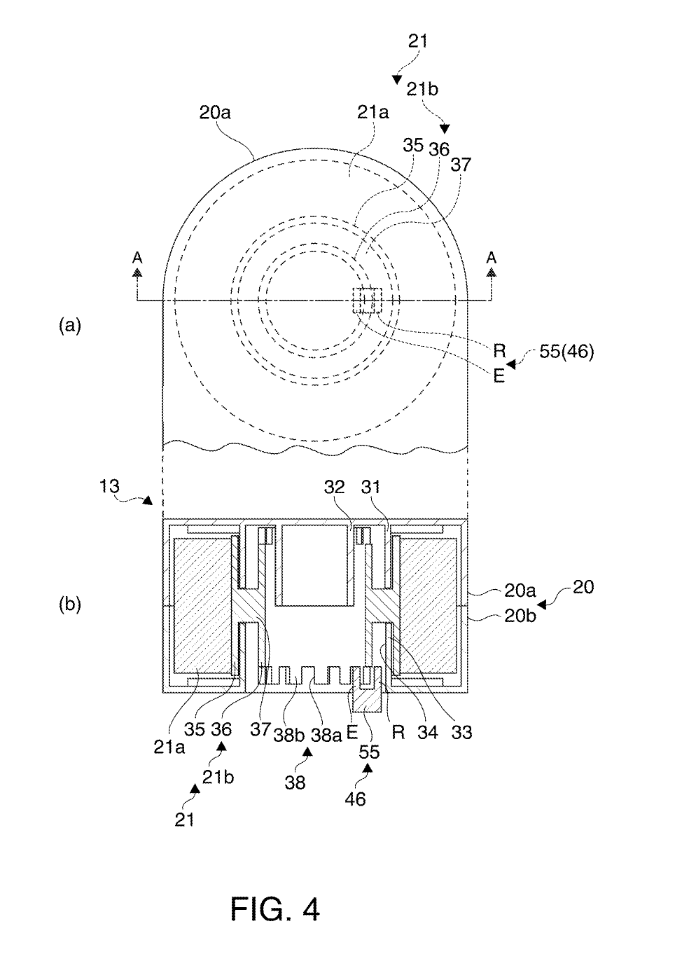

FIG. 3 is a perspective view illustrating a cross section of the tape cartridge 13 taken along a line A-A in FIG. 1. FIG. 4 schematically illustrates the tape cartridge 13, wherein: apart (a) is a plan view of apart of the tape cartridge 13; and a part (b) is a cross-sectional view of the tape cartridge 13 taken along a line A-A in the part (a). As can be seen from FIGS. 3 and 4, an upper core shaft 31 engaging with the tape core 21b and a core bearing 32 disposed inside the upper core shaft 31 and engaging with a positioning projection 53 described later project from the upper case 20a toward the inside. The upper core shaft 31 and the core bearing 32 are coaxially disposed. Each of the upper core shaft 31 and the core bearing 32 is a cylindrical component formed integrally with the upper case 20a. Similarly, a cylindrical lower core shaft 33 for supporting the tape core 21b projects from the lower case 20b toward the inside. The lower core shaft 33 is formed integrally with the lower case 20b and disposed opposite to the upper core shaft 31. A circular detection opening 34 communicating with the device main body 14 is formed inside the lower core shaft 33 in such a position that a rotation detecting unit 46 described later faces the detection opening 34.

Each of the tape core 21b, the ribbon core 22b, and the winding core 23 is a cylindrical component disposed between the upper case 20a and the lower case 20b. Though not shown in the figure, each of the tape core 21b, the ribbon core 22b, and the winding core 23 has a rotation stop mechanism which is released when the tape cartridge 13 is attached to the device main body 14.

The tape core 21b has an outer cylindrical portion 35, an inner cylindrical portion 36, and an annular connecting portion 37 for connecting the outer cylindrical portion 35 and the inner cylindrical portion 36 at an intermediate position, each of the portions 35, 36 and 37 is formed integrally with one another to forma dual cylindrical shape on the whole. The printing tape 21a is wound around the outside surface of the outer cylindrical portion 35. The upper core shaft 31 and the lower core shaft 33 engage with the inside of the outer cylindrical portion 35 such that the annular connecting portion 37 is sandwiched between the upper core shaft 31 and the lower core shaft 33 in the up-down direction.

A detection portion 38 as a detection target of the rotation detecting unit 46 described later is formed integrally with the lower area of the inner cylindrical portion 36. The detection portion 38 according to the first embodiment has a plurality of light transmission portions 38a as rectangular notches in the circumferential direction of the inner cylindrical portion 36 and a plurality of light shield portions 38b as parts other than the notches disposed alternately at equal intervals. When the rotation of the tape core 21b (the detection portion 38) is detected by the rotation detecting unit 46, pulse signals are produced. The numbers of the light transmission portions 38a and the light shield portions 38b may be arbitrarily determined as long as at least one for each is provided. In addition, the light transmission portions 38a and the light shield portions 38b are not required to be equipped at equal intervals. That is, it is only required that at least one portion for transmitting light received from the rotation detecting unit 46 or at least one portion for shielding the light is provided as the detection portion 38. The position of the detection portion 38 (the light transmission portions 38a and light shield portions 38b) is not limited to the position in the circumferential direction of the inner cylindrical portion 36 but may be any position as long as the detection portion 38 is rotary in accordance with the rotation of the tape core 21b and can detect the rotation of the tape core 21b in cooperation with the rotation detecting unit 46 described later. The light transmission portions 38a are not limited to rectangular notches but may be notches in arbitrary shapes or may be openings in lieu of notches. Furthermore, when the tape core 21b is transparent, a seal (tape) having stripes corresponding to the plural light transmission portions 38a and the plural light shield portions 38b may be affixed to the inner cylindrical portion 36.

The printing tape 21a drawn from the tape core 21b is guided by a tape guide pin 36 to reach the platen roller 24. On the other hand, the ink ribbon 22a drawn from the ribbon core 22b is guided toward a first ribbon pin 27 and a second ribbon pin 28 while tensioned to reach the platen roller 24. The ink ribbon 22a having reached the platen roller 24 opposed to the thermal head 12a is subjected to the printing process by the thermal head 12a while being fed with the printing tape 21a overlapped on the ink ribbon 22a. The printing tape 21a after printing is delivered to the outside of the tape cartridge 13 through a tape outlet 29 formed on the side surface of the cartridge case 20. The ink ribbon 22a moves around within the cartridge case 20 to be wound around the winding core 23.

The device main body 14 constituting the main part of the tape feeding device 11 is now explained. As illustrated in FIG. 1, the device main body 14 has a device case 41 forming the outer case of the device main body 14, and a cartridge attachment section 42 to which the tape cartridge 13 is attached. The device main body 14 further includes an operation unit 43 having a keyboard 43a as an input device directly operated by a user and a display 43b (notifying unit) which displays the input result and the like received through the keyboard 43a, a tape feeding unit 44 which feeds the printing tape 21a while drawing the printing tape 21a from the tape cartridge 13, a cutter unit 45 which cuts the printing tape 21a after printing, and the rotation detecting unit 46 (see FIG. 5) which detects the rotation condition including rotation stop of the tape core 21b.

The keyboard 43a is positioned on the front half part of the upper surface of the device case 41, and the display 43b is positioned on the right rear half part of the upper surface of the device case 41. An opening and closing cover 47 is provided on the left rear half part of the upper surface of the device case 41. The cartridge attachment section 42 is concaved inside the opening and closing cover 47. The tape printing unit 12 and the tape feeding unit 44 are equipped within the cartridge attachment section 42 in such a manner as to be hidden from the appearance. A tape identifying sensor 79 described later (see FIG. 5) is provided at a corner of the cartridge attachment section 42 to identify the type and the like of the cartridge case 20.

The tape feeding unit 44 includes a platen drive shaft 51 for driving the platen roller 24 to feed the printing tape 21a, a winding drive shaft 52 for driving the winding core 23 to wind the ink ribbon 22a, the positioning projection 53 for positioning the tape core 21b, a feed motor 54 (see FIG. 5) for rotating the platen drive shaft 51 and the winding drive shaft 52 in synchronization with each other, a train of gearings (not shown) for transmitting the driving force of the feed motor 54 to the platen drive shaft 51 and the winding drive shaft 52. The feed motor 54 and the train of gearings are contained in a lower space below the bottom plate of the cartridge attachment section 42.

When the tape cartridge 13 is attached to the cartridge attachment section 42, the positioning projection 53 engages with the core bearing 32. In addition, the platen drive shaft 51 engages with the platen roller 24, and the winding drive shaft 52 engages with the winding core 23. Simultaneously, the thermal head 12a contacts the platen roller 24 with the printing tape 21a and the ink ribbon 22a sandwiched between the thermal head 12a and the platen roller 24 to come into print stand-by condition.

A tape ejection slot 48 for connecting the cartridge attachment section 42 and the outside of the device is provided on the left side of the device case 41. The cutter unit 45 (cutter) faces the tape ejection slot 48 to cut the printed part of the printing tape 21a fed through the tape ejection slot 48 in the tape width direction and produce a tape piece (label) by actuation of a cutter motor 45a.

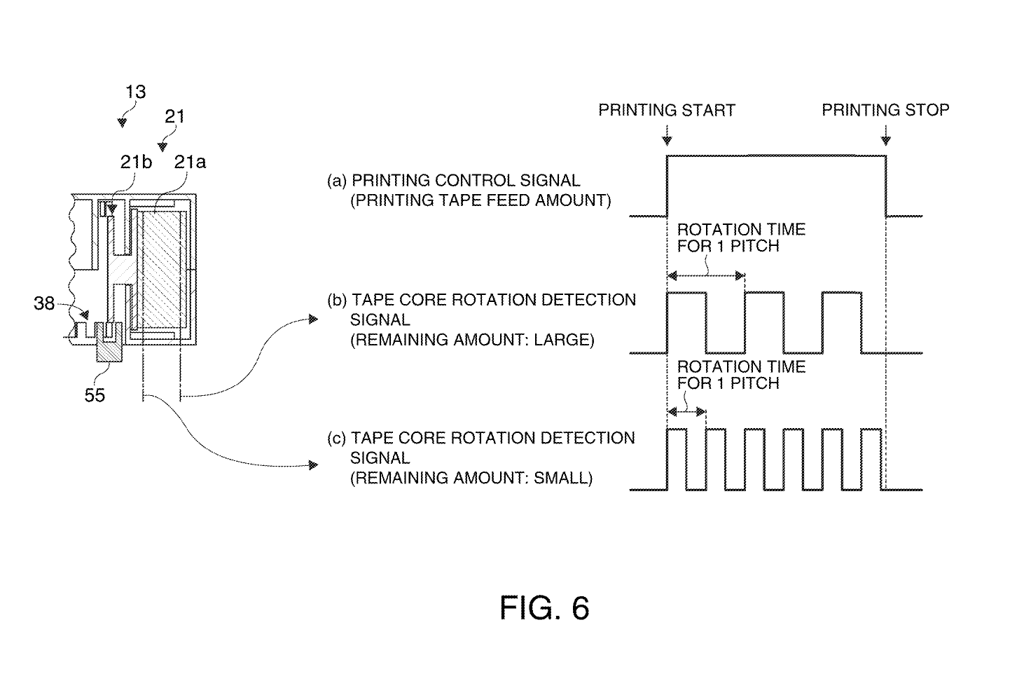

As illustrated in FIGS. 3 and 4, the rotation detecting unit 46 is a photo-sensor which detects electromagnetic energy such as light. According to the first embodiment, a transmission type photo-sensor (photo-sensor) 55 having a light emitting element E and a light receiving element R disposed opposite to each other is used as an example of the photo-sensor. The transmission type photo-sensor 55 is a so-called photo-interrupter having a converting circuit which detects the intermittence and intensity of light and converts the detection result into electric signals. The light emitting element E and the light receiving element R of the transmission type photo-sensor 55 are positioned upward to face the detection portion 38 of the tape core 21b. When the tape core 21b rotates, the transmission type photo-sensor 55 detects output change of voltage produced by the plural light transmission portions 38a and the plural light shield portions 38b of the detection portion 38. This output change is transmitted to the control device 15 to be recognized as pulse signals (rotation detection signals) (see graph (a) and graph (b) in FIG. 6), based on the pulse signals and pulse signals of the control device 15, the control device 15 determines the rotation condition of the tape core 21b (such as rotation time and circular-arc length). By this method, the control device 15 is allowed to recognize the accurate condition of the printing tape 21a being drawn and fed.

The control device 15 is now explained with reference to FIG. 5. FIG. 5 is a block diagram of the control device 15 included in the tape printing apparatus 1. The control device 15 has a control unit 61 (control unit) for controlling the respective components of the device main body 14, a drive unit 62 for driving the respective components of the device main body 14, and a type detection unit 63 (type detecting unit) for detecting the type of the tape cartridge 13.

The control unit 61 includes a CPU 70, a ROM 71, a RAM 72, and an IOC (input output controller) 73, all of which are connected with one another via an internal bus 74. The CPU 70 carries out various calculations under a control program contained in the ROM 71 and expanded to the RAM 72. The CPU 70 performs functions such as various process controls by processing input and output of respective signals including printing control signals and rotation detection signals of the tape core 21b between the CPU 70 and the respective components of the device main body 14 via the IOC 73. The CPU 70 has a timer 80 for updating the internal time.

The ROM 71 has a control table 81 which stores a feeding speed Vf for feeding the printing tape 21a and the ink ribbon 22a by the tape feeding unit 44, and parameters PM for each of the types of the tape cartridge 13 (or the printing tape 21a). The control table 81 stores the parameters PM including a tape thickness Tt of the printing tape 21a, a core diameter Dc of the tape core 21b (the outer cylindrical portion 35 of the tape core 21b), and a split number Se of the detection portion 38 (the number of pairs of the light transmission portion 38a and the light shied portion 38b provided in the circumferential direction).

When the type of the tape cartridge 13 is detected by the type detection unit 63, the corresponding parameters PM and the like are supplied from the control table 81 to the RAM 72. The CPU 70 calculates a remaining amount Lx of the printing tape 21a contained in the tape cartridge 13 based on the feeding speed Vf of the printing tape 21a and the like, the parameters PM, and the detection result from the rotation detecting unit 46. The feeding speed Vf is a fixed value (constant), and the tape thickness Tt, the core diameter Dc, and the split number Se are determined for each type of the tape cartridge 13. The details of this method will be described later.

The drive unit 62 includes a head driver 75, a display driver 76, a feed motor driver 77, and a cutter motor driver 78 provided to pass input/output signals received from the control unit 61 to the thermal head 12a, the display 43b, the feed motor 54, and the cutter motor 45a and also to actuate these components.

The type detection unit 63 has the tape identifying sensor 79 (microswitch) disposed at the corner of the cartridge attachment section 42 as discussed above. The tape identifying sensor 79 detects a plurality of detection holes (not shown) formed on the rear surface of the cartridge case 20 and identifies the attachment and the type of the tape cartridge 13 based on the combination (bit pattern) of the plural detection holes.

Detection of the tape end (finish of the printing tape 21a), detection of looseness and the like of the printing tape 21a, and calculation of the remaining amount Lx of the printing tape 21a by using the control device 15 are now described.

The detection of the tape end is initially explained. According to the tape printing apparatus 1 in the first embodiment, the printing tape 21a is drawn from the tape core 21b, and the ink ribbon 22a is drawn from the ribbon core 22b in accordance with the rotations of the platen roller 24 and the winding core 23 as discussed above. Thus, it can be determined whether the printing tape 21a and the like are being drawn and fed in the normal condition based on the detection of the rotation of the tape core 21b in synchronization with the feeding operation of the printing tape 21a and the like carried out by the tape printing unit 12. When the printing tape 21a is finished, the printing tape 21a to be drawn does not exist on the tape core 21b. As a result, the rotation of the tape core 21b stops.

Therefore, the detection of the tape end corresponds to the detection by the rotation detecting unit 46 that the tape core 21b does not rotate. When the tape end is detected, the CPU 70 stops the operations of the feed motor 54 and the thermal head 12a according to the control program, and displays on the display 43b that replacement of the tape cartridge 13 is needed so as to notify the user about this fact.

By this method, the tape end can be accurately detected by using the tape core 21b without providing a special process on the printing tape 21a to indicate the tape end. Thus, the printing tape 21a (and the tape body 21 as well) can be manufactured at low cost. Moreover, since the operation of the feed motor 54 and the like is stopped before the printing tape 21a is finished, execution of the printing operation under the condition that the printing tape 21a does not exist between the thermal head 12a and the platen roller 24 (printing position) can be avoided. The information that the printing tape 21a is being fed in the normal condition may be displayed on the display 43b as well as the tape end. In addition, the time period from the detection of the tape end to the stop of the feed motor 54 and the like may be prolonged so as to use the largest possible part of the printing tape 21a.

The detection of looseness and the like of the printing tape 21a is now explained. When the printing tape 21a wound around the tape core 21b is loosened or cut, or when the printing tape 21a is loosened or entangled in the course from the tape core 21b to the thermal head 12a for some reasons, for example, the loosened printing tape 21a is fed after the start of operation of the feed motor 54. In this case, the tape core 21b does not rotate for a short period or does not rotate at all, that is, the printing tape 21a comes into an abnormal feeding condition.

For solving this problem, the tape printing apparatus 1 according to the first embodiment establishes a predetermined time for detecting looseness and the like (stores the predetermined time in the ROM 71), and determines that the printing tape 21a is in the abnormal feed condition when detecting the rotation of the tape core 21b before the elapse of the predetermined time from the start of operation of the feed motor 54. In this case, the CPU 70 stops the operation of the feed motor 54 according to the control program, and displays the information about the abnormal condition on the display 43b to notify the user about the information. By this method, the user can check whether the printing tape 21a within the tape cartridge 13 is loosened or in other abnormal condition. When the problems such as looseness of the printing tape 21a produce no obstacle to printing or the like, the operation stop of the feed motor 54 and the display on the display 43b are not required. However, when the predetermined time discussed above is set, the abnormal condition of the printing tape 21a produced by looseness or the like of the printing tape 21a is not erroneously detected as the tape end.

Concerning the detection of the tape end explained above, the case in which the rotation of the tape core 21b is stopped during the rotation of the tape core 21b (during feeding of the printing tape 21a) has been discussed. However, when the tape cartridge 13 containing the finished printing tape 21a is accidentally attached, for example, this condition can be detected as the tape end based on the fact that the rotation of the tape core 21b is not detected after the elapse of the predetermined time.

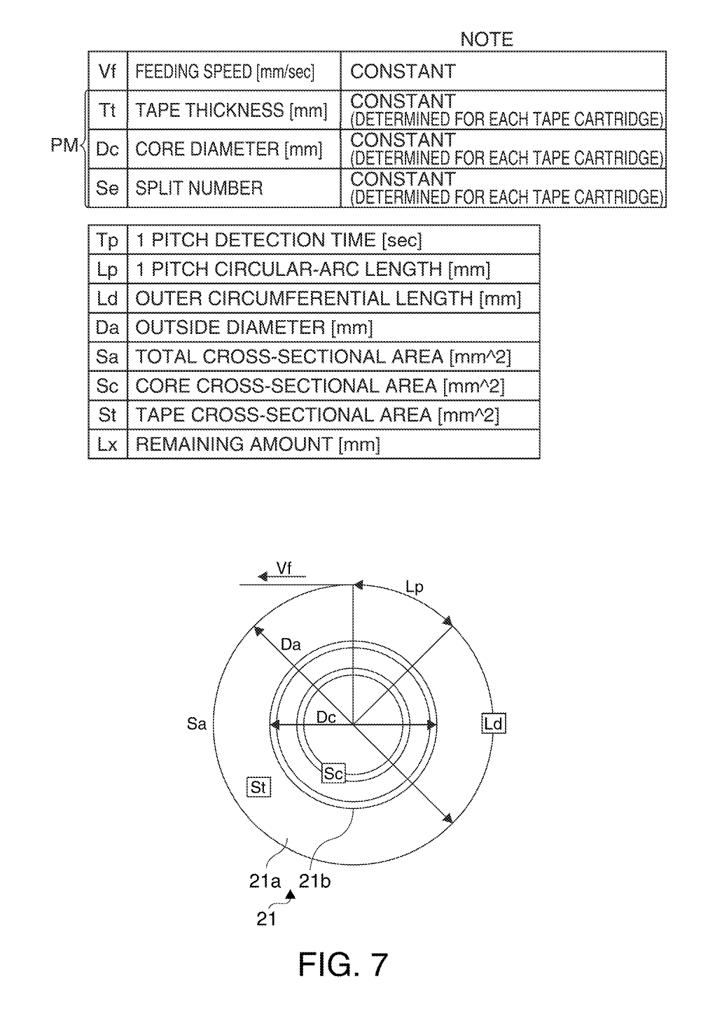

The calculation of the remaining amount Lx of the printing tape 21a is explained with reference to FIGS. 6 and 7. FIG. 6 shows the relationship between the remaining amount Lx of the printing tape 21a and the rotation detection signal detected by the rotation detecting unit 46. FIG. 7 shows respective constants and variables used for the calculation of the remaining amount Lx of the printing tape 21a. According to the tape printing apparatus 1 in the first embodiment, the feed amount of the printing tape 21a (peripheral speed of the tape body 21 (see graph (a) in FIG. 6)) is constant as shown in FIG. 6. However, the rotation speed of the tape core 21b decreases when the remaining amount Lx is large (see graph (b) in FIG. 6), and the rotation speed of the tape core 21b increases when the remaining amount Lx is small (see graph (c) in FIG. 6). That is, the rotation speed of the tape core 21b is inversely proportional to the diameter of the tape body 21 (outside diameter Da).

Accordingly, the tape printing apparatus 1 in the first embodiment calculates the remaining amount Lx of the printing tape 21a from pulse signals (rotation detection signals) and the like detected by the rotation detecting unit 46 based on the inversely proportional relationship between the rotation speed of the tape core 21b and the outside diameter Da of the tape body 21.

Initially, when the rotation detecting unit 46 detects the rotation of the tape core 21b after the start of the printing process on the printing tape 21a, the CPU 70 measures a time required for the rotation for each one pitch of the detection portion 38 (the combined length of the one light transmission portion 38a and the one light shield portion 38b: 1 pulse) as a time hereinafter referred to as 1 pitch detection time Tp by using the timer 80 provided on the CPU 70. The 1 pitch detection time Tp is temporarily stored in the RAM 72. Then, the CPU 70 calculates the remaining amount Lx of the printing tape 21a from the 1 pitch detection time Tp and the feeding speed Vf, and the respective parameters PM (tape thickness Tt, core diameter Dc, and split number Se) read from the control table 81 and supplied to the RAM 72.

The specific calculation steps are now explained with reference to FIG. 7. Initially, the circular-arc length of the tape body 21 for the rotation of 1 pitch (hereinafter referred to as 1 pitch circular-arc length Lp) is calculated from the feeding speed Vf and the 1 pitch detection time Tp (see Equation (1)). Then, an outer circumferential length Ld of the tape body 21 at the corresponding time is calculated from the 1 pitch circular-arc length Lp and the split number Se (see Equation (2)), and the outside diameter Da of the tape body 21 at the corresponding time is calculated from the outer circumferential length Ld (see Equation (3)).

Lp=Vf×Tp (1)

Ld=Lp×Se (2)

Da=Ld/π (3)

Next, a total cross-sectional area Sa of the tape body 21 is calculated from the obtained outside diameter Da of the tape body 21 (see Equation (4)). Similarly, the cross-sectional area of the tape core 21b (hereinafter referred to as core cross-sectional area Sc) is calculated from the core diameter Dc (see Equation (5)). Then, the cross-sectional area of the printing tape 21a wound around the tape core 21b (hereinafter referred to as tape cross-sectional area St) is calculated from the difference between the total cross-sectional area Sa and the core cross-sectional area Sc (see Equation (6)). Finally, the remaining amount Lx of the printing tape 21a is calculated from the obtained tape cross-sectional area St and the tape thickness Tt (see Equation (7)).

Sa=(Dâ2)×π/4 (4)

Sc=(Dĉ2)×π/4 (5)

St=Sa−Sc (6)

Lx=St/Tt (7)

After the remaining amount Lx of the printing tape 21a is calculated, the CPU 70 displays the result on the display 43b to notify the user about this information. By this method, the user can check the information and determine whether the tape cartridge 13 needs to be replaced or not before the printing tape 21a is finished according to the length of the necessary printing tape 21a. The remaining amount Lx may be displayed on the display 43b by indicator display as well as numerical display.

According to the example discussed above, the core cross-sectional area Sc is calculated from the core diameter Dc determined for each type of the tape cartridge 13 stored in the control table 81. However, the core cross-sectional area Sc for each type of the tape cartridge 13 may be stored in place of the core diameter Dc. In addition, while the display 43b is used for notifying the user about the information on the printing tape 21a (tape end, looseness and others, and remaining amount Lx) in the first embodiment, a warning lamp such as LED, warning sound from a speaker or the like may be employed for the notification.

### Second Embodiment

It is possible to calculate the remaining amount Lx of the printing tape 21a not by the calculation method according to the first embodiment but from the rotation speed of the tape core 21b. More specifically, the 1 pitch length (distance) of the detection portion 38 for each type of the tape cartridge 13, and the correspondence table showing the correlation between the rotation speed of the tape core 21b for each type of the tape cartridge 13 and the remaining amount Lx at the corresponding rotation speed are stored in the control table in place of the feeding speed Vf and the respective parameters PM (tape thickness Tt, core diameter Dc, and split number Se). The CPU 70 calculates the rotation speed of the tape core 21b from the 1 pitch length and the 1 pitch detection time Tp, and obtains the corresponding remaining amount Lx based on the calculation result by referring to the control table 81 (correspondence table). Thus, the remaining amount Lx can be easily calculated based on the detection result from the rotation detecting unit 46 only by referring to the control table 81 (correspondence table). Other structures are similar to those in the first embodiment, and the same explanation is not repeated.

According to the first and second embodiments, it is accurately determined whether the printing tape 21a is being fed in the normal condition. Thus, supply of the printing tape 21a can be automatically stopped by detection of the condition that the printing tape 21a is finished, the looseness and entanglement of the printing tape 21a, and other conditions. Accordingly, the problems such as continuation of the printing process by the tape printing unit 12 without supply of the printing tape 21a can be avoided.

### Third Embodiment

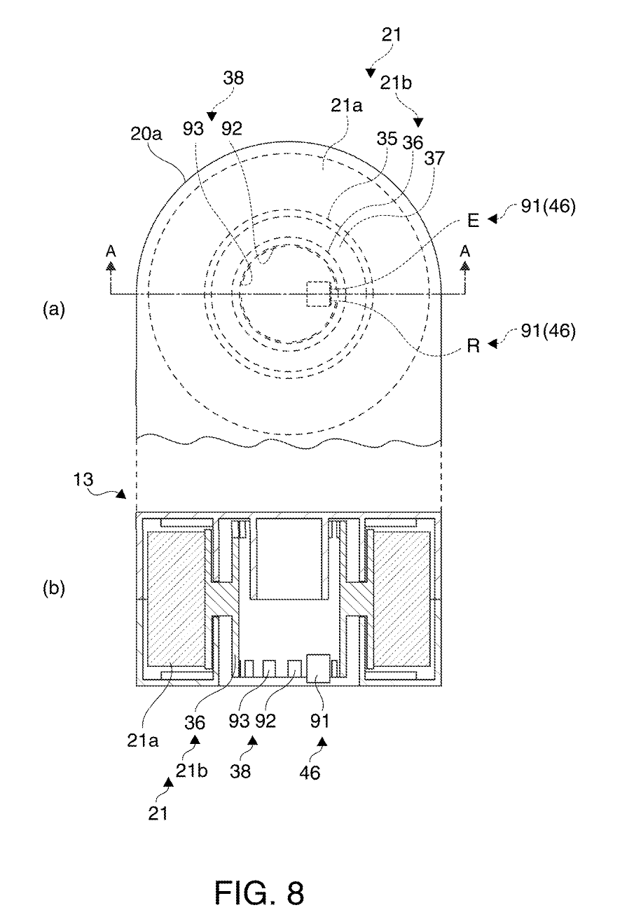

The tape printing apparatus 1 according to a third embodiment is now described with reference to FIG. 8. FIG. 8 schematically illustrates the tape cartridge 13 in the third embodiment, wherein: a part (a) is a plan view of a part of the tape cartridge 13; and apart (b) is a cross-sectional view of the tape cartridge 13 taken along a line A-A in the part (a). The tape printing apparatus 1 according to the third embodiment includes a reflection type photo-sensor (photo-sensor) 91 having the light emitting element E and the light receiving element R disposed in the same direction as a photo-sensor constituting the rotation detecting unit 46. The reflection type photo-sensor 91 detects the intermittence and intensity of the light by receiving, by the light receiving element R, the light which is emitted from the light emitting element E toward the detection portion 38 and which is reflected by the detection portion 38. In the third embodiment, the reflection type photo-sensor 91 is disposed in such a position as to face the inside of the inner cylindrical portion 36 of the tape core 21b. In accordance with this structure, the detection portion 38 in the third embodiment has a plurality of light reflection portions 92 which reflect light emitted from the light emitting element E and a plurality of light non-reflection portions 93 which prevent reflection of light from the light emitting element E disposed alternately at equal intervals. When the tape core 21b rotates, the light emitted from the light emitting element E and not reflected by the areas of the light non-reflection portions 93 changes output from the reflection type photo-sensor 91, thereby allowing detection of the rotation condition of the tape core 21b (acquirement of pulse signals). The conditions of the detection portion 38 in the third embodiment such as the provided number and intervals are arbitrarily determined similarly to the first embodiment. That is, it is only required that at least one area reflecting the light from the rotation detecting unit 46 or one area not reflecting the light from the rotation detecting unit 46 is provided. The position of the detection portion 38 (the light reflection portions 92 and the light non-reflection portions 93) is not limited to the position in the circumferential direction of the inner cylindrical portion 36. The conditions of the light reflection portions 92 and the light non-reflection portions 93 such as shape and the material may be arbitrarily determined. Other structures are similar to those in the first embodiment, and the same explanation is not repeated.

### Fourth Embodiment

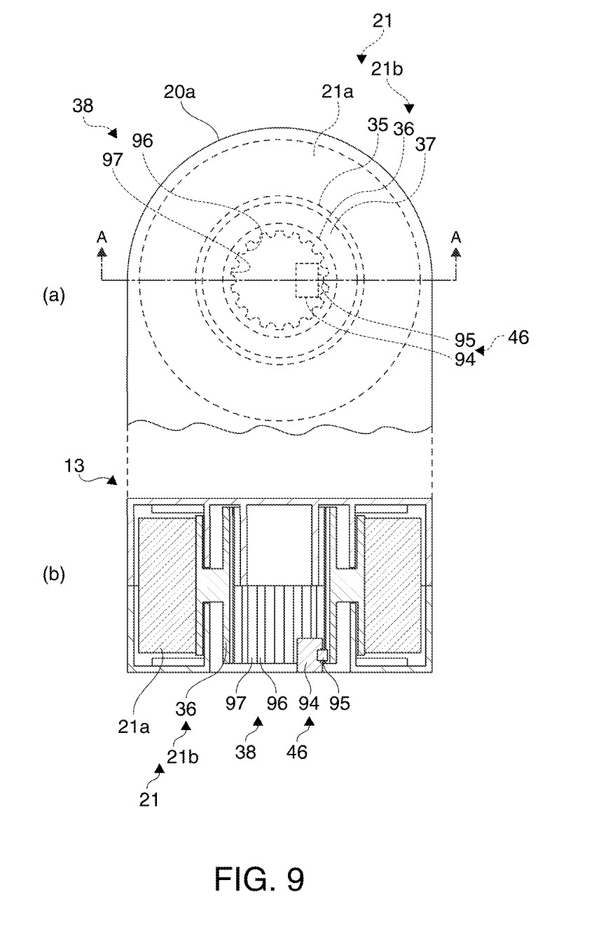

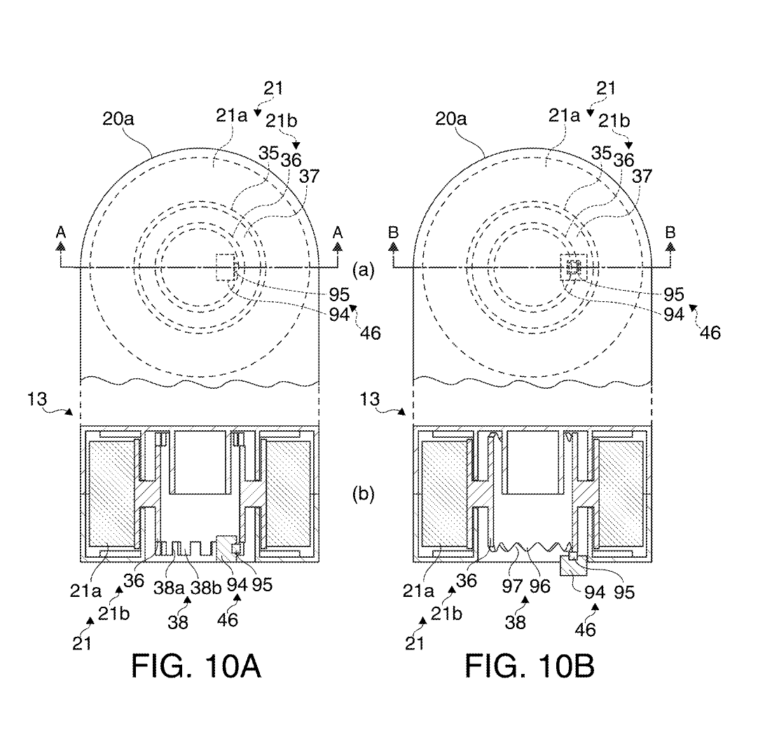

The tape printing apparatus 1 according to a fourth embodiment is now described with reference to FIGS. 9 and 10. FIG. 9 schematically illustrates the tape cartridge 13 in the fourth embodiment, wherein: a part (a) is a plan view of a part of the tape cartridge 13; and a part (b) is a cross-sectional view of the tape cartridge 13 taken along a line A-A in the part (a). FIGS. 10A and 10B illustrate a tape cartridge, a tape body and other components according to a modified example of the fourth embodiment, wherein: parts (a) in FIGS. 10A and 10B are plan views of these components; a part (b) in FIG. 10A is a cross-sectional view of the tape cartridge taken along a line A-A in the part (a) in FIG. 10A; and a part (b) in FIG. 10B is a cross-sectional view of the tape cartridge taken along a line B-B in the part (a) in FIG. 10B. According to the tape printing apparatus 1 in the fourth embodiment, the rotation detecting unit 46 has a microswitch 94 facing the inside of the inner cylindrical portion 36 of the tape core 21b. In accordance with this structure, the detection portion 38 in the fourth embodiment has convexes 96 for pushing (turning on) a switch end 95 of the microswitch 94 and concaves 97 for releasing (turning off) the push of the switch end 95 disposed alternately at equal intervals in the inner lower region of the inner cylindrical portion 36 in the circumferential direction. The microswitch 94 is disposed in such a position as to bring the switch end 95 for switching between on and off of the microswitch 94 into contact with the convexes 96. When the tape core 21b rotates, the convexes 96 and the concaves 97 switch between on and off of the microswitch 94, allowing detection of the rotation condition of the tape core 21b (acquirement of pulse signals). Alternatively, as illustrated in FIG. 10A, the detection portion 38 may have rectangular notches similar to those of the detection portion 38 in the first embodiment in place of the convexes 96 and the concaves 97. Also, as illustrated in FIG. 10B, the detection portion 38 may have the wave-shaped convexes 96 and concaves 97 on the lower end surface of the inner cylindrical portion (see FIG. 10B). In this case, the switch end 95 of the microswitch 94 is disposed upward in such a manner as to contact the wave-shaped convexes 96 and concaves 97. The conditions of the convexes 96 and concaves 97 such as the provided number and intervals are arbitrarily determined as long as at least one for each is provided. That is, it is only required that the detection portion 38 has at least the area for pushing the switch end 95 or the area for releasing the push of the switch end 95 is provided. The position of the detection portion 38 (the convexes 96 and the concaves 97) is not limited to the position in the circumferential direction of the inner cylindrical portion 36 as long as the detection portion 38 is rotary by the rotation of the tape core 21b and is disposed at a position for detecting the rotation of the tape core 21b in cooperation with the rotation detecting unit 46. The conditions of the convexes 96 and the concaves 97 such as shape and the material may be arbitrarily determined. Other structures are similar to those in the first embodiment, and the same explanation is not repeated.

The position of the rotation detecting unit 46 (photo-sensor: the transmission type photo-sensor 55, the reflection type photo-sensor 91, and the microswitch 94) in the first through fourth embodiment is not limited to the position according to these examples but may be changed as long as the rotation detecting unit 46 can detect the rotation of the tape core 21b. For example, the rotation detecting unit 46 in the third and fourth embodiments may be disposed outside the inner cylindrical portion 36. In this case, the detection portion 38 is structured such that the rotation detecting unit 46 can face the detection portion 38.

### Fifth Embodiment

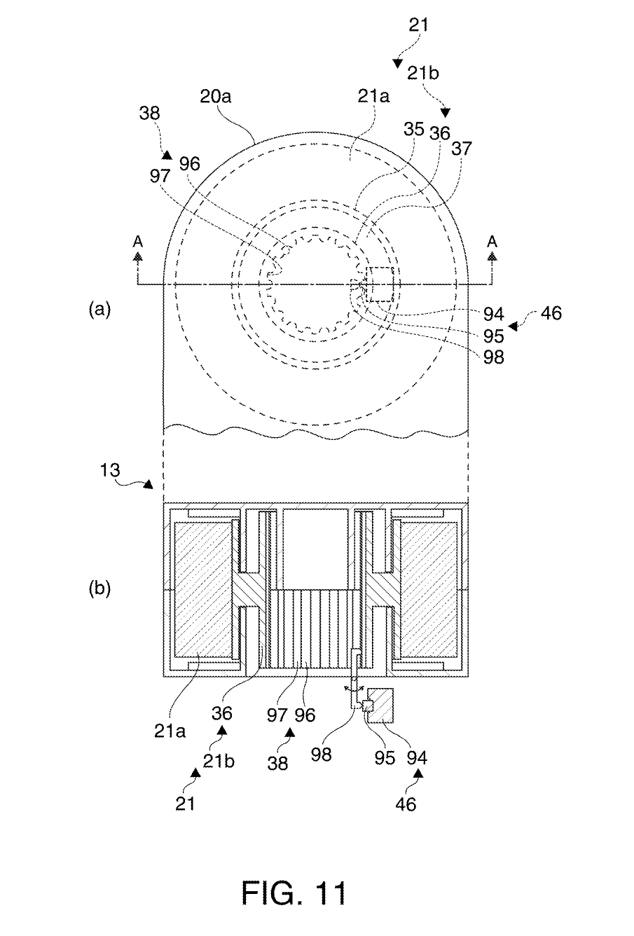

The tape printing apparatus 1 according to a fifth embodiment is now described with reference to FIG. 11. FIG. 11 schematically illustrates the tape cartridge 13 in the fifth embodiment, wherein: a part (a) is a plan view of a part of the tape cartridge 13; and a part (b) is a cross-sectional view of the tape cartridge 13 taken along a line A-A in the part (a). According to the tape printing apparatus 1 in the fifth embodiment, the rotation detecting unit 46 has the microswitch 94, and the detection portion 38 has the convexes 96 and the concaves 97 similarly to the fourth embodiment. However, turning on and off of the microswitch 94 is switched not by direct contact between the switch end 95 of the microswitch 94 and the convexes 96 but by using a pivot member 98. The microswitch 94 is disposed below the lower end surface of the inner cylindrical portion 36 with the switch end 95 facing the inside. The pivot member 98 is a bar-shaped member which pivots around its center as the movement axis. The upper end of the pivot member 98 is so structured as to contact the convexes 96, and the lower end of the pivot member 98 is so structured as to contact the switch end 95. When the tape core 21b rotates, the pivot member 98 moves in accordance with the shapes of the convexes 96 and the concaves 97, thereby repeating push and release of the switch end 95. By this method, turning on and off of the microswitch 94 can be switched without direct contact between the switch end 95 of the microswitch 94 and the convexes 96. Accordingly, malfunction and failure caused by abrasion of the switch end 95 can be prevented. The rotation detecting unit 46 (microswitch 94) in the fifth embodiment is not required to be disposed at the position in this example but may be located such that the switch end 95 of the microswitch 94 faces outside, for example. Other structures are similar to those in the first embodiment, and the same explanation is not repeated.

According to the third through fifth embodiments, the rotation of the tape core 21b can be accurately detected similarly to the other embodiments. Thus, the detection of the feeding condition and the tape end and the calculation of the remaining amount Lx of the printing tape 21a can be highly accurately achieved.

While the detection of the tape end of the printing tape 21a, the detection of looseness and the like of the printing tape 21a, and the calculation of the remaining amount Lx are performed based on detection of the rotation of the tape core 21b in the first through fifth embodiments, these steps may be carried out based on detection of the rotation of the ribbon core 22b. That is, a “tape-shaped material” in the appended claims is not limited to the printing tape 21a but may be the ink ribbon 22a or other tape-shaped materials.

What is claimed is:

1. A tape feeding device comprising:
a device main body to which a tape body, which has a tape-shaped material wound around a tape core, is detachably attached,
wherein the device main body includes
a tape feeding unit which feeds the tape-shaped material while drawing the tape-shaped material from the tape core, and
a rotation detecting unit which detects the rotation condition of the tape core including rotation stop in cooperation with the tape core.

2. The tape feeding device according to claim 1, wherein:
the device main body further includes a control unit which controls the operation of the tape feeding unit; and
the control unit stops the operation of the tape feeding unit when the rotation detecting unit detects rotation stop of the tape core.

3. The tape feeding device according to claim 1, wherein:
the device main body further includes a control unit which controls the operation of the tape feeding unit and a type detecting unit which detects the type of the attached tape body;
the control unit includes a control table storing various parameters for each type of the tape body;
the control unit refers to the control table based on the detection result received from the type detecting unit; and
the control unit calculates the remaining amount of the tape-shaped material based on the feeding speed of the tape feeding unit, the detection result received from the rotation detecting unit, and the reference result obtained from the control table.

4. The tape feeding device according to claim 1, wherein:
the tape core includes at least a detection portion; and
the rotation detecting unit has a photo-sensor facing the detection portion.

5. The tape feeding device according to claim 1, wherein:
the tape core includes at least a detection portion; and
the rotation detecting unit has a microswitch which contacts the detection portion to be turned on or off.

6. The tape feeding device according to claim 1, wherein the device main body further includes a notifying unit which notifies the rotation condition of the tape-shaped material.

7. A tape printing apparatus comprising:
the tape feeding device according to claim 1; and
a tape printing unit which performs printing on the tape-shaped material drawn and fed.
